(19) United States
(12) Patent Application Publication
(10) Pub. No.: US 2002/0075931 A1
(43) Pub. Date: Jun. 20, 2002

(54) Air-cooled gas laser and associated method for cooling thereof

(75) Inventor: Fuqian Tang, Orlando, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: T&S Team Incorporated, Orlando, FL

(21) Appl. No.: 10/017,430

(22) Filed: Dec. 14, 2001

Related U.S. Application Data
(60) Provisional application No. 60/255,762, filed on Dec. 15, 2000.

(51) Int. Cl. H01S 3/22; H01S 3/223

(52) U.S. Cl. 372/55

(57) ABSTRACT

An air-cooled gas laser assembly includes a gas discharge tube, and an air-cooled heat exchanger adjacent the gas discharge tube. A stationary intervening layer is mechanically and thermally connected between the gas discharge tube and the air-cooled heat exchanger and includes a thermally conductive pliable material. The stationary intervening layer may be in direct contact with the gas discharge tube and the air-cooled heat exchanger. The thermally conductive pliable material may include a paste material, a liquid, or a silicone rubber mixed with a metallic powder.

### RELATED APPLICATION

This application is based upon prior filed provisional application Serial No. 60/255,762 filed Dec. 15, 2000, the entire contents of which is incorporated herein by reference.

### FIELD OF THE INVENTION

The present invention relates to lasers, and more particularly, to an air-cooled gas laser.

### BACKGROUND OF THE INVENTION

The general construction of a conventional gas discharge laser includes three major components. These components include a power supply which is also called the pumping source, an active medium defined within a gas discharge tube, and an optical cavity.

The power supply supplies power necessary to pump or stimulate the active medium within the gas discharge tube. The optical cavity is usually defined by two end mirrors which are parallel to each other. These end mirrors are at respective ends of the gas discharge tube, which is a long, thin enclosure. Hot plasma within the gas discharge tube is the active medium that produces an output laser beam.

For some types of gas lasers, the hot plasma needs to be cooled for the laser to achieve optimal laser operation. Gas discharged lasers may be water-cooled or air-cooled. Traditionally, gas discharged lasers are water-cooled. However, a water-cooled laser is inconvenient because consumption of the cooling fluid that circulates around the exterior wall of the gas discharge tube to carry away heat energy is required. If the cooling fluid flow fails, the gas discharge tube may break due to the resulting heat, thus causing the laser to fail.

One approach for an air-cooled laser 10 includes a single ceramic block 12 that is machined with a rectangular groove therein, and a second ceramic plate 14 is pressed on top to form a rectangular channel 16 with respect to the rectangular groove, as illustrated in FIGS. 1a-1b. This channel 16 defines the gas discharge area.

The hot plasma is generated in the gas discharge area for laser operation when a voltage is supplied between two metal electrodes 18, 20. This voltage may be provided by a direct current voltage or by a radio frequency voltage. The ceramic material is chosen to be a thermally conductive material. Examples of ceramic materials are aluminum oxide (Al₂O₃) and beryllium oxide (BeO). Due to the high thermal conductivity of the ceramic material, heat energy is transferred therefrom to an air-cooled heat exchanger 22 that is an aluminum extrusion. Heat is removed by blowing air across the outwardly extending fins 24 of the air-cooled heat exchanger 22.

Another approach for an air-cooled laser 30 includes two T-shaped aluminum extrusions 32a, 32b within a gas chamber 34 defined by a hollow square aluminum extrusion 36, as illustrated in FIGS. 2a-2b. The aluminum extrusion 36 also serves as the air-cooled heat exchanger. These T-shaped aluminum extrusions 32a, 32b serve as the electrodes, and the gap 38 therebetween defines the gas discharge area.

The hot plasma is generated for laser operation when a voltage is supplied between the two T-shaped extrusions 32a, 32b. Due to the naturally high thermal conductivity of aluminum, heat energy is transferred from the gas discharge area 38 to the small gaps surrounding the T-shaped extrusions 32a, 32b via helium gas. In almost all CO₂ lasers, for example, there is a high percentage of helium gas which has a high thermal conductivity. Heat is removed by blowing air across the outwardly extending fins 24.

In both examples 10, 30 of an air-cooled laser, the gas discharge area is formed by machined blocks. The heat transfer from one component (the machined blocks defining the gas discharge area) to another component (the air-cooled heat exchanger) is through flat surfaces. An interface of these flat surfaces are either in contact or closely gapped. If closely gapped, helium gas acts as the heat transfer component to bridge the gap.

For the first air-cooled laser 10, it is difficult to machine the groove in the single ceramic block 12. It is also difficult to create the two precisely flat surfaces between the single ceramic block 12 and the second ceramic plate 14 so that they are in good contact when pressed together. The difficulty is due to the ceramic material being very hard and corrosive to machine tools. Certain ceramics, such as BeO, is also extremely toxic when machined, wherein BeO powder is generated in the machining process.

For the second air-cooled laser 30, high precision aluminum blocks are required to keep the gas discharge area straight, and the gaps accurate within the hollow extrusion 36. The inside of the hollow extrusion 36 and the T-shaped extrusions 32a, 32b are first extruded and then precision machined. To mill the inside surfaces of the T-shaped extrusions 32a, 32b is not trivial. It is also difficult to accurately place the T-shaped extrusions 32a, 32b inside the hollow extrusion 36 and fasten them firmly without any electrical contact with the interior walls therein.

### SUMMARY OF THE INVENTION

In view of the foregoing background, an object of the present invention is to provide an air-cooled laser assembly that has a relatively straightforward design.

This and other objects, advantages and features in accordance with the present invention are provided by an air-cooled gas laser assembly comprising a gas discharge tube, an air-cooled heat exchanger adjacent the gas discharge tube, and a stationary intervening layer mechanically and thermally connected between the gas discharge tube and the air-cooled heat exchanger. The stationary intervening layer comprises a thermally conductive pliable material for transferring heat energy from the gas discharge tube to the air-cooled heat exchanger.

The gas discharge tube preferably comprises glass or ceramic, wherein the gas discharge tube may be molded or extruded from the respective materials. A molded or extruded gas discharge tube does not require precisely machined components for defining the gas discharge area. Instead, these tubes are relatively straightforward to produce which allow the manufacturing processes to be simplified.

Moreover, extruded or molded gas discharge tubes are precise in their dimensions. Such precision allows the air-cooled gas laser assembly to be easily designed and manufactured. When the extruded or molded gas discharge tube has a circular cross-section, the output laser beam is round. A round output laser beam is preferred since it is typically considered to be higher quality than a square or rectangular output laser beam. The extruded or molded gas discharge tube thus allows the air-cooled gas laser assembly to provide maximum output laser power and better control of the quality of the output laser beam.

The stationary intervening layer is preferably in direct contact with the gas discharge tube and the air-cooled heat exchanger. Since the stationary intervening layer separates the gas discharge tube and the air-cooled heat exchanger, this avoids having to precisely shape the air-cooled heat exchanger to match the external surface of the gas discharge tube. This feature of the present invention also allows the manufacturing processes to be simplified.

In addition, the air-cooled heat exchanger preferably comprises aluminum, which has a different thermal expansion than a glass or ceramic gas discharge tube. Since the stationary intervening layer is preferably in direct contact with the gas discharge tube and the air-cooled heat exchanger, it acts as a buffer therebetween. If the thermal expansion of the aluminum air-cooled heat exchanger is different than the thermal expansion of the glass or ceramic gas discharge tube, the friction between the two materials will not cause the fragile and brittle gas discharge tube to break when the laser is cooled down to low temperatures, or when the laser assembly is heated by the hot plasma.

The thermally conductive pliable material preferably comprises a paste material, a liquid, or a rubber. The rubber may be silicone mixed with a ceramic powder. The ceramic powder may also comprise an Al₂O₃ powder. The stationary intervening layer may further comprise at least one thermally conductive rigid body in the thermally conductive pliable material. The stationary intervening layer may surround the gas discharge tube. Consequently, the at least one thermally conductive rigid body may also surround the gas discharge tube.

The air-cooled heat exchanger may include separable portions. When the thermally conductive pliable material is a paste material or a rubber, the material may be spread on the gas discharge tube and in the interior portions of the separable halves of the air-cooled heat exchanger, which are then clamped together around the gas discharge tube.

The air-cooled heat exchanger preferably comprises aluminum, which may also be molded or extruded. A molded or extruded air-cooled heat exchanger also allows the manufacturing processes to be simplified. The air-cooled heat exchanger preferably comprises a plurality of outwardly extending fins. The heat energy from the gas discharge tube is removed by blowing air across the fins.

Another aspect of the present invention is directed to a method for cooling a gas laser assembly comprising providing a stationary intervening layer between the gas discharge tube and the air-cooled heat exchanger. The stationary intervening layer preferably comprises a thermally conductive pliable material, and is preferably in direct contact with the gas discharge tube and the air-cooled heat exchanger.

### BRIEF DESCRIPTION OF THE DRAWINGS

FIG. 1a is a cross-sectional view of an air-cooled laser assembly in accordance with the prior art;

FIG. 1b is a cross-sectional side view of the air-cooled laser assembly taken along line A in FIG. 1a;

FIG. 2a is a cross-sectional view of another embodiment of an air-cooled laser assembly in accordance with the prior art;

FIG. 2b is a cross-sectional side view of the air-cooled laser assembly taken along line B in FIG. 2a;

FIG. 3a is a cross-sectional view of an air-cooled laser assembly in accordance with the present invention;

FIG. 3b is a cross-sectional side view of the air-cooled laser assembly taken along line C in FIG. 3a;

FIG. 4a is a cross-sectional view of another embodiment of the air-cooled laser assembly illustrated in FIGS. 3a;

FIG. 4b is a cross-sectional side view of the air-cooled laser assembly taken along line D in FIG. 4a;

FIG. 5a is a cross-sectional view of a DC excited air-cooled laser assembly in accordance with the present invention;

FIG. 5b is a cross-sectional side view of the air-cooled laser assembly taken along line E in FIG. 5a;

FIG. 5c is a cross-sectional side view of an alternate embodiment of the air-cooled laser assembly taken along line E′ in FIG. 5a;

FIG. 6a is a cross-sectional view of a RF excited air-cooled laser assembly in accordance with the present invention; and

FIG. 6b is a cross-sectional side view of the air-cooled laser assembly taken along line F in FIG. 6a.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notations are used to indicate similar elements in alternative embodiments.

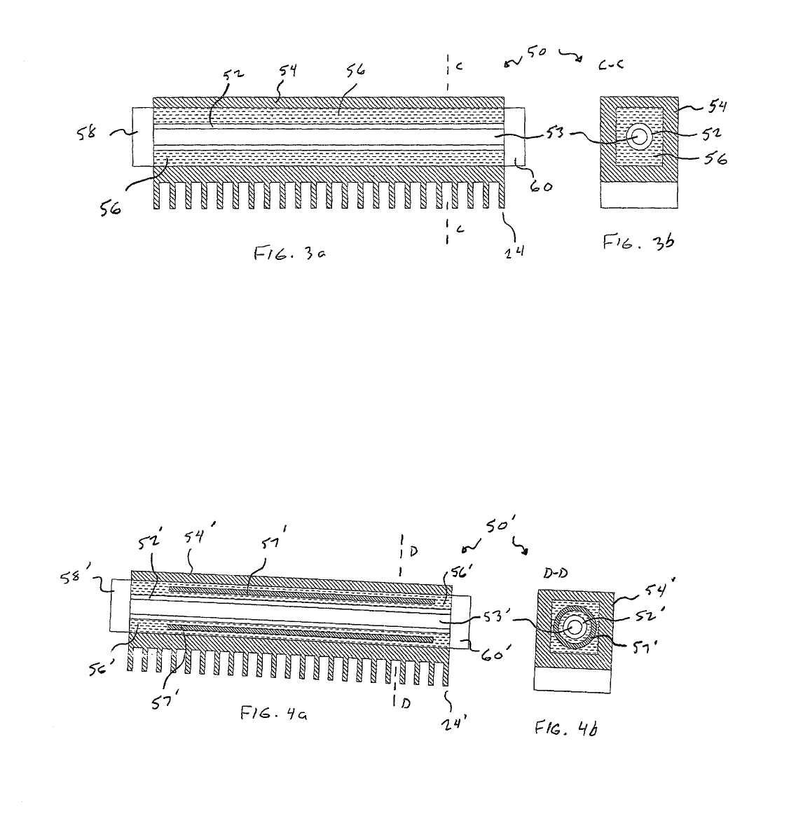

Referring initially to FIGS. 3a-3b, an air-cooled gas laser assembly 50 in accordance with the present invention is first described. The illustrated air-cooled gas laser assembly 50 includes a gas discharge tube 52, an air-cooled heat exchanger 54 adjacent the gas discharge tube, and a stationary intervening layer 56 therebetween. The stationary intervening layer 56 comprises a thermally conductive pliable material, as will be discussed in greater detail below.

The stationary intervening layer 56 is advantageously used to fill in the space between the gas discharge tube 52 and the air-cooled heat exchanger 54, and to also conduct heat energy away from the gas discharge tube to the air-cooled heat exchanger. In this manner, the air-cooled heat exchanger 54 no longer needs to be specially shaped to match the outer surface of the gas discharge tube 52, nor does it have to match the thermal expansion coefficient of the gas discharge tube. This enables a high quality laser assembly to be produced, whereby the gas discharge area 53 is provided using a molded or extruded tube 52 instead of being formed from precision machined components.

The gas discharge tube 52 is preferably a molded or extruded tube formed out of glass or ceramic. Metal tubes are not used because a metal tube is an electrically conductive enclosure that will not allow an electrical charge to form. Plastic tubes are not used because plastic will release contaminating gases into the gas discharge area 53. However, the gas discharge tube 52 is not limited to being formed out of glass or ceramic, as readily appreciated by one skilled in the art.

The air-cooled heat exchanger 54 may comprise aluminum, which may also be molded or extruded. A molded or extruded air-cooled heat exchanger 54 also allows the manufacturing processes to be simplified. The air-cooled heat exchanger 54 also includes a plurality of outwardly extending fins 24. The heat energy from the gas discharge tube 52 is removed by blowing air across the fins 24.

Even though the illustrated gas discharge tube 52 has a circular shape, other shapes are acceptable, such as square and rectangular shapes, for example. When the extruded or molded gas discharge tube 52 has a circular cross-section, the output laser beam is round. A round output laser beam is preferred since it is typically considered to be higher quality than a square or rectangular output laser beam. The extruded or molded gas discharge tube 52 thus allows the air-cooled gas laser assembly 50 to provide maximum output laser power and better control of the quality of the output laser beam.

The stationary intervening layer 56 comprises a thermally conductive pliable material that has good heat conductivity. The thermally conductive pliable material may be in the form of a fluid, a thermally conductive paste, or a soft and thermally conductive rubber. The fluid may be water or an anti-freeze type fluid, for example. Half cured rubber, which is soft, is a good choice if this type of rubber is too hard when fully cured. Almost all rubber materials have very low thermal conductivity, but specially formulated rubbers can have good thermal conductivity.

Since the stationary intervening layer 56 has an adaptable shape, there is no need to precisely match the shape of the air-cooled heat exchanger 54 with the gas discharge tube 52. In addition, the air-cooled heat exchanger is typically a different type material (e.g., aluminum) than the gas discharge tube (e.g., glass or ceramic), which has a different thermal expansion. Since the stationary intervening layer 56 is preferably in direct contact with the gas discharge tube 52 and the air-cooled heat exchanger 54, it acts as a buffer therebetween. If the thermal expansion of the aluminum air-cooled heat exchanger 54 is different than the thermal expansion of the glass or ceramic gas discharge tube 52, the friction between the two materials will not cause the fragile and brittle gas discharge tube to break when the laser is cooled down to low temperatures, or when the laser assembly is heated by the plasma.

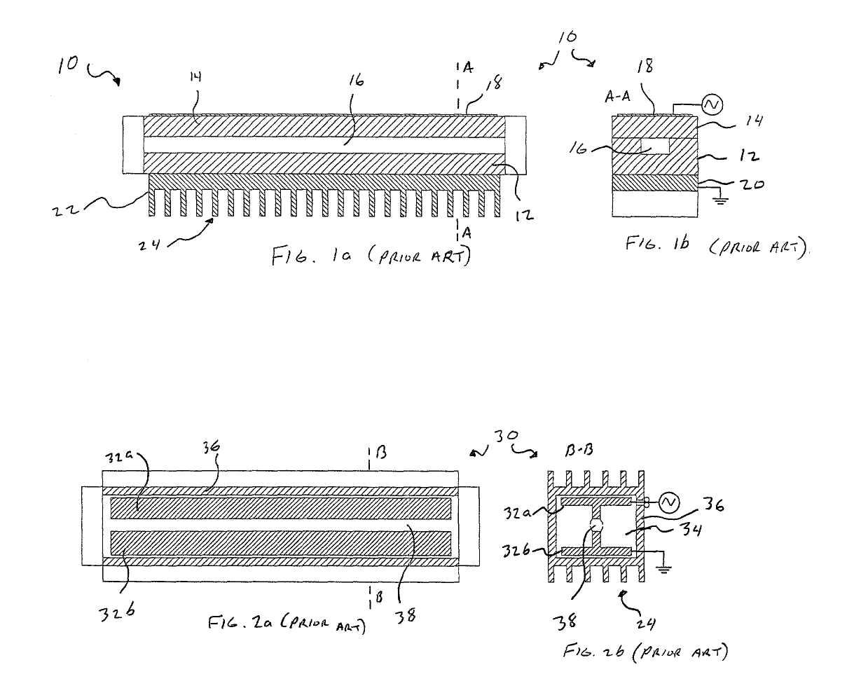

In comparison with a water-cooled gas laser assembly, the air-cooled gas laser assembly 50 according to the present invention does not require a cooling fluid to flow, which in turns does not require a water pump or refrigerator to cool the cooling fluid within a closed loop system. The air-cooled laser assemblies 10, 30 illustrated in FIGS. 1a-2b are more difficult to produce because the gas discharge area must be precisely machined.

The gas discharge tube 52 and the air-cooled heat exchanger 54 in the air-cooled gas laser assembly 50 according to the present invention simplifies manufacturing processes and lowers cost because the glass or ceramic gas discharge tube is an extruded or molded tube. Extruded or molded tubes are readily available and are inexpensive. The air-cooled heat exchanger 54 may also be molded or extruded, as noted above.

In addition, extruded or molded gas discharge tubes 52 are usually precise in their dimensions with respect to straightness, inner diameter and outer diameter. Such precision allows relatively straightforward designs and manufacturing processes, maximum output laser power, and better control of the output laser beam quality.

Another advantage of using an extruded or molded gas discharge tube 52 is that these tubes are usually round, as discussed above. A gas discharge tube 52 having a round cross section produces a round laser output beam when both near the laser output mirror and far away from the laser output mirror. A round laser beam is considered to be of a higher quality as compared to square and rectangular laser beams.

To ease manufacturing processes, it is also desirable to avoid the need to precisely place components inside enclosed chambers, as required for the air-cooled lasers 10, 30 illustrated in FIGS. 1a-2b. It is also desirable to avoid the need of very high precision machining, particularly to materials that are tough and corrosive to machine tools. The extruded or molded gas discharge tube 52 advantageously allows the manufacturing processes to be simplified.

The optical cavity for the illustrated air-cooled gas laser assembly is defined by two end mirrors 58, 60 which are parallel to each other. These end mirrors 58, 60 are at respective ends of the gas discharge tube 52. One end mirror is totally reflective and the other end mirror is partially reflective so that the two end mirrors reflect laser light back and forth through the active medium 53 for amplifying the intensity of the light within the optical cavity. That portion of the light which passes through the partially reflective end mirror forms the output laser beam.

Referring now to the embodiment 50′ illustrated in FIGS. 4a-4b, the stationary intervening layer 56′ may further comprise at least one thermally conductive rigid body 57′ in the thermally conductive pliable material. The stationary intervening layer 56′ may surround the gas discharge tube 52′. Consequently, the thermally conductive rigid body 57′ also surrounds the gas discharge tube 52′. The at least one thermally conductive rigid body 57′ is not limited to a ring as illustrated, but may instead be a plurality of rods or a plurality of granular particulars, for example.

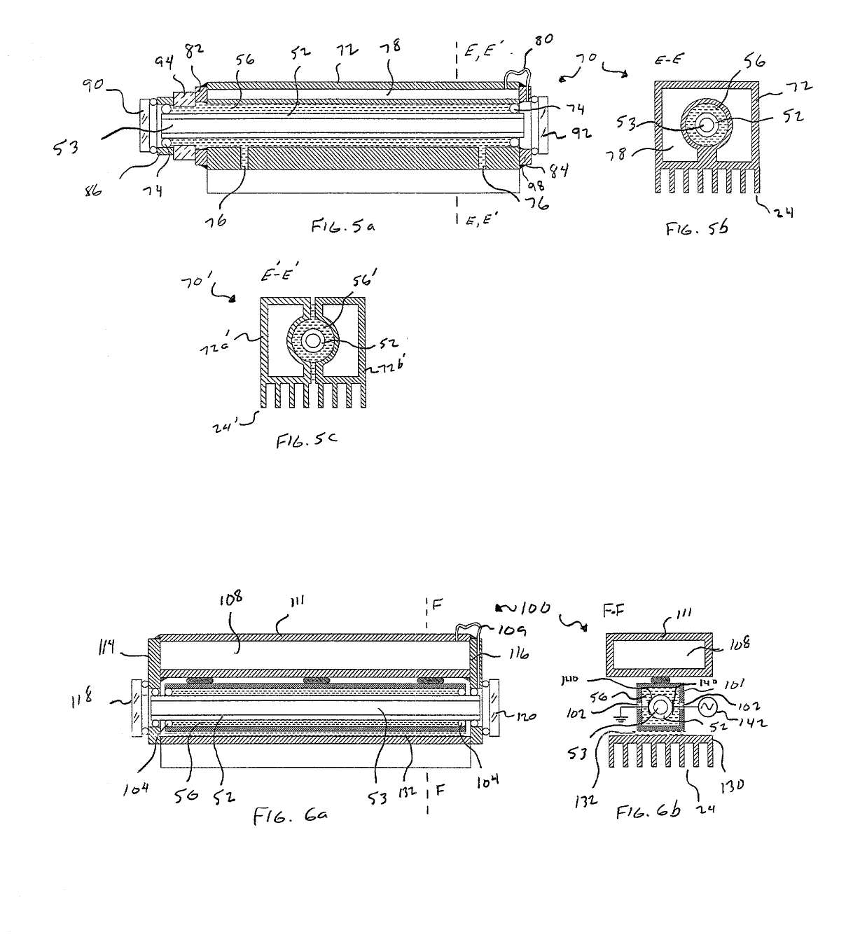

Two specific examples of an air-cooled gas laser assembly will now be discussed with reference to FIGS. 5a-5b. The air-cooled gas laser assembly 70 illustrated in FIGS. 5a-5c is directed to a DC excited CO₂ laser, whereas the air-cooled gas laser assembly 100 in FIGS. 6a-6b is directed to a RF excited CO₂ laser.

Referring now to FIGS. 5a-5c, the illustrated gas laser assembly 70 is a 30 W DC excited air-cooled CO₂ laser. The gas discharge tube 52, which may be glass or ceramic, for example, is surrounded by a soft, heat-conductive filling, i.e., the stationary intervening layer 56.

The stationary intervening layer 56 is in turn surrounded by an aluminum extrusion 72, which functions as the air-cooled heat exchanger. The stationary intervening layer 56 is held in place between the gas discharge tube 52 and the air-cooled heat exchanger by o-rings 74. Methods other than o-rings 74 are also acceptable, such as the use of silicone glue to seal the two ends, for example.

The stationary intervening layer 56 may be filled through the two illustrated openings 76. The gas in the gas discharge tube 52 is the active laser medium when a discharge is present. The gas in the gas discharge tube 52 is in fluid connection with the gas reservoir 78 through the small capillary metal tubing 80. Reference is directed to U.S. patent Ser. No. 09/xxx,xxx filed Oct. 29, 2001, and U.S. patent Ser. No. 09/906,261 concerning different type interfaces between the gas discharge tube 52 and the gas reservoir 78. The contents of these applications are incorporated herein by reference. The end plates 82, 84 are welded to the ends of the air-cooled heat exchanger 72 to seal the gas reservoir 78.

A metallic total reflector holder 86 holds the total reflector end mirror 90. The total reflector holder 86 is also the high voltage electrode, which is insulated by the non-metallic, insulating spacer 94. A metallic partial reflector holder 84 not only seals the gas reservoir 78 through the welds 98, but also acts as the holder of the partial reflector output mirror 92, and as the low voltage electrode. Heat conducts from the gas discharge area 53 to the wall of the gas discharge tube 52, to the stationary intervening layer 56, and to the air-cooled heat exchanger 72. Air is forced across the outwardly extending fins 24 to remove the heat energy.

The thermally conductive pliable material within the stationary intervening layer 56 will now be discussed in greater detail. The thermally conductive pliable material is preferably a soft filling. One type of soft filling is rubber. The rubber may include silicone rubber doped with an Al₂O₃ powder, for example. The Al₂O₃ powder is a thermally conductive material so that by adding it into the silicone rubber, the silicone rubber becomes thermally conductive.

The silicone rubber, mixed with the Al₂O₃ powder, is in a liquid or semi-flowable paste state. A curative agent may be mixed with it before usage. While still in the liquid, semi-liquid, or paste state, it can be poured or pressure driven into the gap between the gas discharge tube 52 and the air-cooled heat exchanger 54 through the illustrated two openings 76. After being poured in, the stationary intervening layer 56 cures over time and becomes soft rubber. In case the type of silicone is too hard, a predetermined amount of a curative agent (i.e., an insufficient amount) can be added so that the rubber will be half cured and will stay soft. Such silicone rubber is not electrically conductive.

A second kind of thermally conductive pliable material is a paste material. For example, OMEGATHERM 201 is a sticky, semi-flowable, soft paste that remains in this pasty state. OMEGATHERM 201 is produced by Omega Corporation in Sanford, Conn. and is formulated specially for high thermal conductivity. Again it can be poured or pressure driven into the gap between the gas discharge tube 52 and the air-cooled heat exchanger 54 through the openings 76. This type of paste is not electrically conductive.

The first and second kind of fillings described above can be more easily filled in between the gas discharge tube 52′ and the air-cooled heat exchanger 54′ if the heat exchanger is made up of separable portions 72a′, 72b′, as illustrated in FIG. 5c. One can simply smear the filling material on the gas discharge tube 52′ and in the interior of the separable portion 72a′, 72b′, and then clamp the portions together around the gas discharge tube.

A third kind of soft filling material is a liquid. If the air-cooled heat exchanger 54 is made of metal, the liquid should not be electrically conductive like water. However, if the air-cooled heat exchanger 54 is not metallic, water can be used for only the DC excited laser. Here, the cooling liquid or water is not flowing. The heat is eventually removed by air, not by flowing water.

The openings 76 can be plugged after the filling is done. The glass or ceramic gas discharge tube 52 can be either Pyrex glass or other similar brand glass tubes, or even an aluminum oxide Al₂O₃ ceramic tube. In the illustrated embodiment, the inner diameter of the gas discharge tube 52 may be about 5 mm, and the total length may be about 30 inches.

The total reflector end mirror 90 is at a wavelength of 10.6 μm. The partial reflector end mirror 92 has a 15-20% output at a wavelength of 10.6 μm. The laser gas may be a mixture of 15% carbon dioxide (CO₂), 15% nitrogen (NA) and 70% helium (He). However, other types of gas are also applicable to the present invention, as readily appreciated by one skilled in the art. Total gas pressure is in a range of about 50-55 Torrs.

Delrin plastic or other types of insulation material can be used for the insulator spacers 94. Stainless steel can also be used for the high voltage electrode. By applying high voltage to the high voltage electrode for generating a discharge plasma, one can obtain a maximum output laser power in the range of 25-40 W. The corresponding input energy is about 200 W. A fan blows air across the outwardly extending fins 24 for continuous laser operation. By varying certain parameters such as the length of the laser and the input power wattage, one can obtain various levels of laser output power.

Referring now to FIGS. 6a-6b, the illustrated gas laser assembly 100 is a 25 W RF excited air-cooled CO₂ laser. As with the example above, the gas discharge tube 52, which may be glass or ceramic, for example, is surrounded by a soft, heat-conductive filling, i.e., a layer of the stationary intervening layer 56.

The stationary intervening layer 56 is in turn surrounded by an aluminum extrusion 101 for enclosing the stationary intervening layer. The stationary intervening layer 56 is held in place between the gas discharge tube 52 and the aluminum extrusion 101 by o-rings 104. Methods other than o-rings 104 are also acceptable, such as the use of silicone glue to seal the two ends, for example.

The stationary intervening layer 56 may be filled through the two illustrated openings 102. The gas in the gas discharge tube 52 is the active laser medium when a discharge is present. The gas in the gas discharge tube 52 is in fluid connection with the gas reservoir 108 through the small capillary metal tubing 109. The gas reservoir 108 is defined by the reservoir enclosure 111. The end plates 114, 116 are welded to the ends of the reservoir enclosure 111 to seal the gas reservoir 108.

A metallic total reflector holder, also indicated by reference 114, holds the total reflector end mirror 118. A metallic partial reflector holder 84, which is also indicated by reference 116, holds the partial reflector output mirror 120. Heat conducts from the gas discharge area 53 to the wall of the gas discharge tube 52, to the stationary intervening layer 56, and to the aluminum extrusion 101. An air-cooled heat exchanger 130 is adjacent the aluminum extrusion 101 for dissipating heat therefrom. In the illustrated example, another stationary intervening layer 132 is in direct contact with the air-cooled heat exchanger 130 and the aluminum extrusion 101. Air is forced across the outwardly extending fins 24 to remove the heat energy.

The thermally conductive pliable material within the stationary intervening layer 56 and 130 is the same as above. The total reflector end mirror 118 is at a wavelength of 10.6 μm. The partial reflector end mirror 120 has a 15-20% output at a wavelength of 10.6 μm. The laser gas may be a mixture of 15% carbon dioxide (CO₂), 15% nitrogen (NA) and 70% helium (He), for example. Total gas pressure is in a range of about 50-55 Torrs.

By applying RF power between the pair of electrodes 140 connected to the gas discharge tube 52, a discharge plasma is generated, and a maximum output laser power in the range of 20-35 W can be obtained. One of the electrodes is connected to ground, and the other electrode is connected to an RF power source 142. The corresponding input energy is about 200 W.

Because there is no high voltage, there is no need for insulation spacers as in the previous DC excited laser example. The gas reservoir extrusion 111 and the air-cooled heat exchanger 130 are two separate aluminum extrusions, not one whole piece as in the previous example. There is additional soft thermal conductive material 132 to fill the gap therebetween, as discussed above.

We can see that in both examples above, we only needed to use extruded or molded glass or ceramic tubes as the gas discharge tubes. Such tubes are round, straight, and inexpensive. The heat exchangers and the gas reservoirs are also made of low cost aluminum extrusions. High precision and high quality laser beams can be obtained without high precision machined components and precision assembly.

Another aspect of the present invention is directed to a method for cooling a gas laser assembly comprising placing an air-cooled heat exchanger 54 adjacent a gas discharge tube 52, and inserting a stationary intervening layer 56 between the gas discharge tube and the air-cooled heat exchanger. The stationary intervening layer 56 preferably comprising a thermally conductive pliable material, and is preferably inserted in direct contact with the gas discharge tube 52 and the air-cooled heat exchanger 54.

Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that modifications and embodiments are intended to be included within the scope of the appended claims.

That which is claimed is:

1. An air-cooled gas laser assembly comprising:
a gas discharge tube;
an air-cooled heat exchanger adjacent said gas discharge tube; and
a stationary intervening layer mechanically and thermally connected between said gas discharge tube and said air-cooled heat exchanger and comprising a thermally conductive pliable material.

2. An air-cooled gas laser assembly according to claim 1, wherein said stationary intervening layer is in direct contact with said gas discharge tube and said air-cooled heat exchanger.

3. An air-cooled gas laser assembly according to claim 1, wherein said thermally conductive pliable material comprises a paste material.

4. An air-cooled gas laser assembly according to claim 1, wherein said thermally conductive pliable material comprises a liquid.

5. An air-cooled gas laser assembly according to claim 1, wherein said thermally conductive pliable material comprises silicone rubber mixed with a metallic powder.

6. An air-cooled gas laser assembly according to claim 5, wherein the metallic powder comprises an Al₂O₃ powder.

7. An air-cooled gas laser assembly according to claim 1, wherein said stationary intervening layer further comprises at least one thermally conductive rigid body in said thermally conductive pliable material.

8. An air-cooled gas laser assembly according to claim 7, wherein said rigid body has a tubular shape surrounding said gas discharge tube.

9. An air-cooled gas laser assembly according to claim 1, wherein said gas discharge tube comprises at least one of glass and ceramic.

10. An air-cooled gas laser assembly according to claim 1, wherein said air-cooled heat exchanger surrounds said gas discharge tube.

11. An air-cooled gas laser assembly according to claim 10, wherein said air-cooled heat exchanger comprises separable portions.

12. An air-cooled gas laser assembly according to claim 1, wherein said air-cooled heat exchanger comprises a plurality of outwardly extending fins.

13. An air-cooled gas laser assembly according to claim 1, further comprising a pair of electrodes connected to said gas discharge tube.

14. An air-cooled gas laser assembly comprising:
a gas discharge tube;
an air-cooled heat exchanger surrounding said gas discharge tube; and
a stationary intervening layer between and in direct contact with said gas discharge tube and said air-cooled heat exchanger, said stationary intervening layer comprising a thermally conductive pliable material.

15. An air-cooled gas laser assembly according to claim 14, wherein said thermally conductive pliable material comprises at least one of a paste material, a liquid, and a silicone rubber mixed with a metallic powder.

16. An air-cooled gas laser assembly according to claim 15, wherein the metallic powder comprises an Al₂O₃ powder.

17. An air-cooled gas laser assembly according to claim 14, wherein said stationary intervening layer further comprises at least one thermally conductive rigid body in said thermally conductive pliable material.

18. An air-cooled gas laser assembly according to claim 17, wherein said rigid body has a tubular shape surrounding said gas discharge tube.

19. An air-cooled gas laser assembly according to claim 14, wherein said gas discharge tube comprises at least one of glass and ceramic.

20. An air-cooled gas laser assembly according to claim 14, wherein said air-cooled heat exchanger comprises separable portions.

21. An air-cooled gas laser assembly according to claim 14, wherein said air-cooled heat exchanger comprises a plurality of outwardly extending fins.

22. An air-cooled gas laser assembly according to claim 14, further comprising a pair of electrodes connected to said gas discharge tube.

23. A method for cooling a gas laser assembly comprising:
providing a stationary intervening layer between a gas discharge tube and an air-cooled heat exchanger, the stationary intervening layer comprising a thermally conductive pliable material.

24. A method according to claim 23, wherein the stationary intervening layer is in direct contact with the gas discharge tube and the air-cooled heat exchanger.

25. A method according to claim 23, wherein the thermally conductive pliable material comprises at least one of a paste material, a liquid, and a silicone rubber mixed with a metallic powder.

26. A method according to claim 23, wherein the stationary intervening layer further comprises at least one thermally conductive rigid body in the thermally conductive pliable material.

27. A method according to claim 26, wherein the rigid body has a tubular shape surrounding the gas discharge tube.

28. A method according to claim 23, wherein the gas discharge tube comprises at least one of glass and ceramic.

29. A method according to claim 23, wherein the air-cooled heat exchanger surrounds the gas discharge tube.

30. A method according to claim 29, wherein the air-cooled heat exchanger comprises separable portions.
